(19) United States
(12) Patent Application Publication
(10) Pub. No.: US 2026/0032564 A1
(43) Pub. Date: Jan. 29, 2026

(54) SYSTEMS, METHODS, AND DEVICES FOR WIRELESS CONNECTION AND POWER MANAGEMENT

(71) Applicant: Cypress Semiconductor Corporation, San Jose, CA (US)

(72) Inventors: Sandeep Sarma MUNUKUTLA, Bangalore (IN); Sudhirkumar PRAJAPATI, Milpitas, CA (US)

(73) Assignee: Cypress Semiconductor Corporation, San Jose, CA (US)

(21) Appl. No.: 18/911,042

(22) Filed: Oct. 9, 2024

Related U.S. Application Data
(60) Provisional application No. 63/676,872, filed on Jul. 29, 2024.

(51) Int. Cl. H04W 48/10; H04W 48/16

(52) U.S. Cl. CPC H04W 48/10; H04W 48/16

(57) ABSTRACT

Systems, methods, and devices provide wireless connection and power management for wireless devices. Methods include receiving data transmission information during an advertisement period via at least one advertisement response data packets, and determining, using one or more processors of a primary wireless device, if any of a plurality of secondary wireless devices has data to transmit during an upcoming data exchange period, the determining being based on the data transmission information. Methods further include updating, using the one or more processors, a network schedule based on a result of the determining, the updating comprising skipping data exchange operations for at least one of the plurality of secondary wireless devices, and performing, using the one or more processors, data exchange operations using the updated network schedule.

### CROSS-REFERENCE TO RELATED APPLICATIONS

This application claims priority under 35 U.S.C. § 119(e) to U.S. Provisional Application No. 63/676,872, filed Jul. 29, 2024, which is incorporated by reference herein in its entirety for all purposes.

### TECHNICAL FIELD

This disclosure relates to wireless devices, and more specifically, to enhancement of wireless connection and power management in such wireless device.

### BACKGROUND

Wireless devices may include transceivers configured to generate and receive wireless signals in accordance with one or more wireless communications protocols. For example, such wireless devices may establish wireless connections using a wireless communications protocol, such as a Bluetooth protocol. Such wireless connections may implemented in accordance with negotiated schedules used to manage periods of activity. Conventional wireless devices remain limited because they are limited in their ability to efficiently manage such periods of activity and often include unnecessary data exchange operations that increase power consumption.

### BRIEF DESCRIPTION OF THE DRAWINGS

FIG. 1 illustrates an example of a wireless connection management system, configured in accordance with some embodiments.

FIG. 2 illustrates an example of a device for wireless connection management, configured in accordance with some embodiments.

FIG. 3 illustrates an example of a method for wireless connection management, performed in accordance with some embodiments.

FIG. 4 illustrates another example of a method for wireless connection management, performed in accordance with some embodiments.

FIG. 5 illustrates an additional example of a method for wireless connection management, performed in accordance with some embodiments.

FIG. 6 illustrates a diagram of an example of wireless connection operations, configured in accordance with some embodiments.

FIG. 7 illustrates a diagram of another example of wireless connection operations, performed in accordance with some embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as not to unnecessarily obscure the described concepts. While some concepts will be described in conjunction with the specific examples, it will be understood that these examples are not intended to be limiting.

Wireless devices may communicate with each other using wireless connections implemented with each other in accordance with one or more wireless communications protocols. For example, wireless devices may establish wireless connections using a Bluetooth protocol. Moreover, a relationship may be established where one device is a primary or master device, and the other devices are secondary or slave devices. In one example, a primary device may establish wireless connections with multiple secondary devices. Moreover, a schedule may be negotiated to manage data exchanges between the primary device and the different secondary devices. More specifically, time slots may be designated in which a data transmission period is partitioned and allocated amongst the secondary devices in accordance with a negotiated network schedule.

Conventional techniques for performing data exchange in accordance with such network schedules remain limited because they may include numerous unnecessary data exchange operations in which a primary device and a secondary device exchange data at their scheduled time slot simply to confirm that the secondary device has no data to transmit. For example, the primary device may sequentially poll the secondary devices to check with each one to determine if a secondary device has data to transmit. Such inquiries performed by the primary device may be performed at anchor points of the network schedule. In order to respond, the secondary device transitions from a sleep mode to a wake mode, and provides a response. Thus, in conventional techniques, all secondary devices must consume power and use wireless connection bandwidth to switch from a sleep mode to a wake mode and transmit a response message to the primary device even if there is no data payload to be transmitted.

Embodiments disclosed herein provide the ability to dynamically modify network schedules based on data transmission information to reduce unnecessary data transmission operations, and reduce overall power consumption of wireless devices. As will be discussed in greater detail below, a periodic advertisement period may be configured to also include data transmission information from secondary devices. In this way, the primary device may be provided with data transmission information in advance regarding an upcoming data exchange period. The data transmission information may identify which secondary devices have data for transmission and which do not. The primary device may use this information to skip any unnecessary data exchange operations in the upcoming data exchange period, thus reducing channel usage while also reducing power consumption that would otherwise be incurred by such unnecessary data exchange operations.

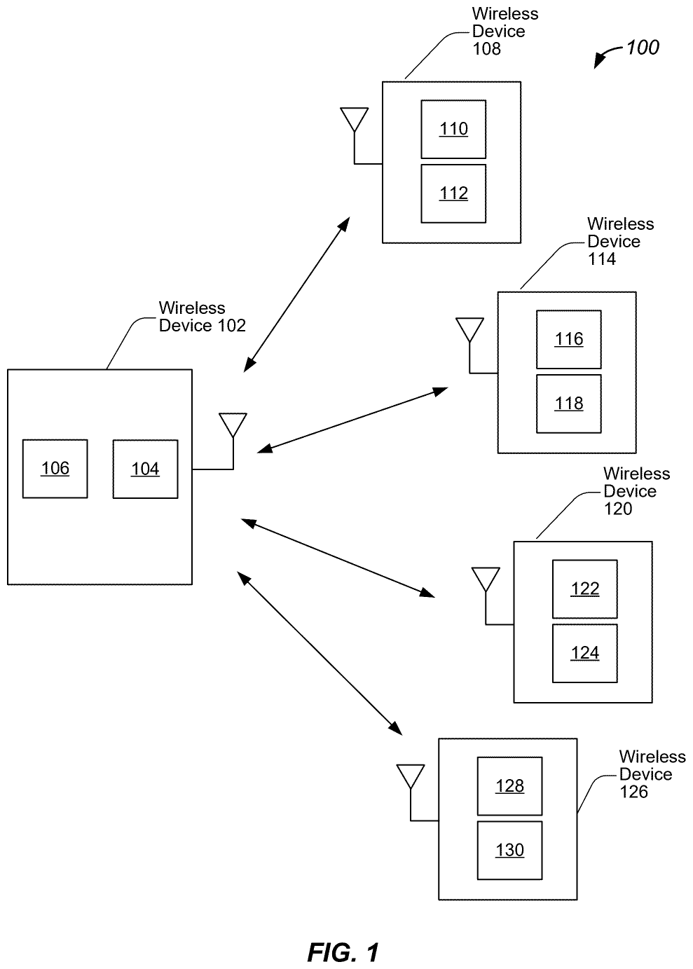

FIG. 1 illustrates an example of a wireless connection management system, configured in accordance with some embodiments. Accordingly, a system, such as system 100, may include wireless devices that are used for wireless communications, and are configured to establish wireless connections used for such wireless communications. As will be discussed in greater detail below, wireless devices included in system 100 may be configured to generate and update network schedules based on transmission data to avoid unnecessary wake and transmission operations, thus resulting in reduced power consumption and wireless channel usage.

In some embodiments, system 100 includes wireless device 102 which is configured to transmit and receive wireless signals in accordance with one or more communications protocols. For example, wireless device 102 may include one or more transceivers, such as transceiver 104, which is configured to transmit and receive signals in accordance with a wireless communications protocol, such as a Bluetooth protocol. In various embodiments, wireless device 102 additionally includes a processing device, such as processing device 106, which is configured to implement various hardware and logic associated with transceiver 104, and its associated wireless communications protocol. For example, processing device 106 may be configured to implement a wireless protocol stack that is configured to control hardware associated with a wireless transmission medium, such as that associated with a Bluetooth transmission medium. As will be discussed in greater detail below, wireless device 102 may be configured as a master device, also referred to herein as a primary device, that manages communication with multiple slave devices, also referred to herein as secondary devices.

Accordingly, wireless device 102 is within communications range of one or more other wireless devices. In one example, wireless device 102 is within range of wireless device 108, wireless device 114, wireless device 120, and wireless device 126. Each wireless device may also have a processing device and transceiver configured to facilitate wireless communications in accordance with a wireless communications protocol, such as a Bluetooth protocol. For example, wireless device 108 may include processing device 110 and transceiver 112. wireless device 114 may include processing device 116 and transceiver 118, wireless device 120 may include processing device 122 and transceiver 124, and wireless device 126 may include processing device 128 and transceiver 130. In various embodiments, wireless device 108, wireless device 114, wireless device 120, and wireless device 126 may be configured as secondary devices while, as discussed above, wireless device 102 is configured as a primary device.

As will be discussed in greater detail below, wireless device 102 may be configured to negotiate a network schedule that is used to manage communications with wireless device 108, wireless device 114, wireless device 120, and wireless device 126. Accordingly, such a network schedule may have designated periodic times, which may be identified by anchor points, at which each secondary device is to transition from a sleep mode to a wake mode, and is provided the opportunity to perform data exchange operations with wireless device 102.

As will be discussed in greater detail below, a periodic advertisement period may be configured to also include data transmission information from secondary devices. Accordingly, a periodic advertisement with response assistance (PAwR) operation may be interleaved with data exchange operations within the network schedule. In various embodiments, the periodic advertisement period may be a bidirectional advertisement capability supported by a Bluetooth Low Energy protocol. Such a periodic advertisement period may be used by a primary device to transmit advertisement beacons to other wireless devices, and also for such other wireless devices to provide a reply, as may occur during a process of connection establishment. As will be discussed in greater detail below, wireless devices disclosed herein may configure the implementation of a periodic advertisement period, which may be a PAwR operation, as an additional logical transport for upcoming transmission information. In this way, the periodic advertisement period may be configured to provide the primary device with data transmission information in advance regarding an upcoming data exchange period with secondary devices, and the primary device may use the data transmission information to update the network schedule to remove data exchange operations that do not include a data payload.

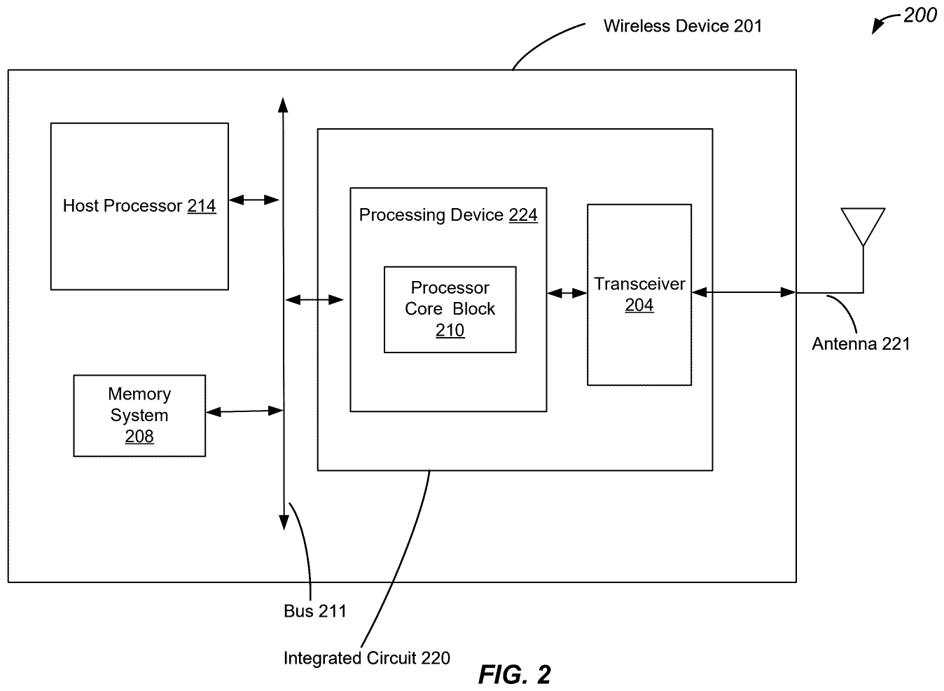

FIG. 2 illustrates an example of a device for wireless connection management, configured in accordance with some embodiments. More specifically, FIG. 2 illustrates an example of a system, such as system 200, that may include wireless device 201. It will be appreciated that wireless device 201 may be one of any of the wireless devices discussed above with reference to FIG. 1, such as wireless device 108, wireless device 114, wireless device 120, and wireless device 126.

In various embodiments, wireless device 201 includes one or more transceivers, such as transceiver 204. In one example, wireless device 201 includes transceiver 204 which is configured to transmit and receive signals using a communications medium that may be accessed and used via antenna 221. As noted above, transceiver 204 may be a Bluetooth transceiver. Accordingly, transceiver 204 may be compatible with a wireless communications protocol, such as a Bluetooth or Bluetooth Low Energy or Bluetooth Smart protocol. In various embodiments, transceiver 204 includes a modulator and demodulator as well as one or more buffers and filters, that are configured to generate and receive signals via antenna 221. Accordingly, transceiver 204 may include chains of components configured to perform such operations, such as a transmit chain and a receive chain.

In various embodiments, system 200 further includes one or more processing devices, such as processing device 224 which may include logic implemented using one or more processor cores. Accordingly, processing device 224 is configured to implement logic for wireless connection management. For example, processing device 224 may be configured to generate and update network schedules, as will be discussed in greater detail below. Accordingly, processing device 224 includes processing elements, that may be included in a processor and/or implemented in firmware, configured to perform wireless connection management and network schedule configuration operations in which determinations are made based on received transmission data.

In various embodiments, processing device 224 includes processor core block 210 that comprises one or more processor cores which are configured to implement a wireless protocol interface. For example, a Bluetooth Low Energy or Bluetooth Smart protocol may be implemented using a Bluetooth stack in which software is implemented as a stack of layers, and such layers are configured to compartmentalize specific functions utilized to implement the Bluetooth communications protocol. In various embodiments, a host stack includes layers for a Bluetooth network encapsulation protocol, radio frequency communication, service discovery protocol, as well as various other high level data layers. Moreover, a controller stack includes a link management protocol, a host controller interface, a link layer which may be a low energy link layer, as well as various other timing critical layers, and such stacks may be implemented via processor core block 210.

System 200 further includes antenna 221 which is configured to transmit and receive wireless signals. In one example, antenna 221 may be coupled to transceiver 204, and may be used to transmit and receive signals from transceiver 204. While FIG. 2 illustrates one antenna, it will be appreciated that wireless device 201 may include multiple antennas.

System 200 includes memory system 208 which is configured to store one or more data values associated with wireless connection management operations discussed in greater detail below. Accordingly, memory system 208 includes storage device, which may be a non-volatile random-access memory (NVRAM) configured to store such data values, and may also include a cache that is configured to provide a local cache. In various embodiments, system 200 further includes host processor 214 which is configured to implement processing operations implemented by system 200.

It will be appreciated that one or more of the above-described components may be implemented on a single integrated circuit, or on different integrated circuits. For example, transceiver 204 and processing device 224 may be implemented on the same integrated circuit, such as integrated circuit 220. In another example transceiver 204 and processing device 224 may each be implemented on their own integrated circuit, and thus may be disposed separately as a multi-die module or on a common substrate such as a printed circuit board (PCB). It will also be appreciated that components of system 200 may be implemented in a variety of contexts, such as the context of a smart home environment, an automotive environment, or a wireless environment including Internet of Things (IoT) devices.

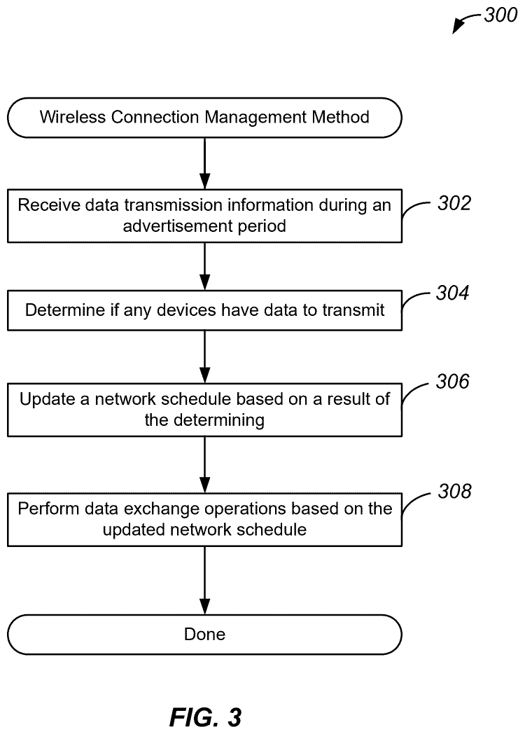

FIG. 3 illustrates an example of a method for wireless connection management, performed in accordance with some embodiments. Accordingly, a method, such as method 300, may be performed to generate network schedules used for wireless communications, and to update such network schedules based on received data transmission information. As will be discussed in greater detail below, the updating of such network schedules may be performed to selectively remove scheduled data exchange operations that do not include a data payload. Removal of such scheduled data exchange operations may reduce overall power consumption and wireless resource usage of the wireless devices.

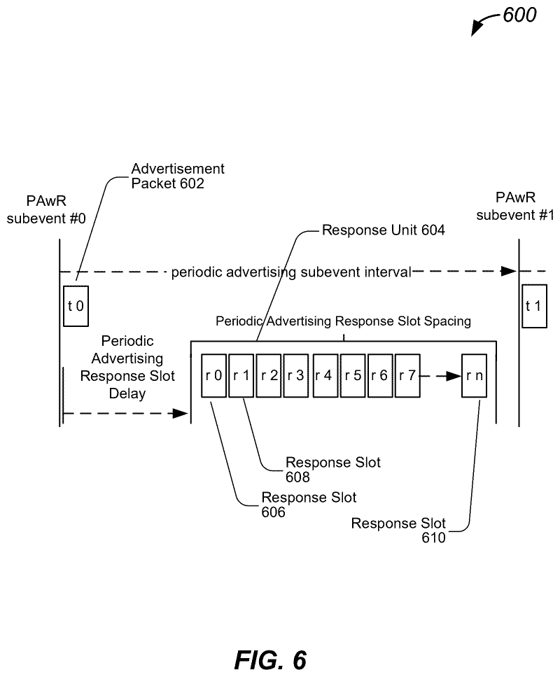

Method 300 may perform operation 302 during which data transmission information may be received during an advertisement period. As discussed above, a periodic advertisement period may be used to perform PAwR operations in accordance with a wireless communications standard, such as a Bluetooth Low Energy standard. Accordingly, a primary device may perform advertisement and scanning activity in which an advertisement frame is broadcast, and secondary devices may provide a response in accordance with scheduled slots within the response period, as will be discussed in greater detail below with reference to FIG. 6. Moreover, the secondary devices may be configured to provide modified responses that identify data transmissions for an upcoming data transmission period. Accordingly, advertisement and response messages disclosed herein may be configured to support the additional inclusion of such data transmission information, thus providing an additional logical transport for such data transmission operation.

Method 300 may perform operation 304 during which it may be determined if any devices have data to transmit. Accordingly, the primary device may receive responses from the secondary devices during the periodic advertisement period. As discussed above, the responses may be modified data objects that are configured to additionally include one or more identifiers configured to identify whether or not the secondary device associated with the reply has a data payload to transmit. Such an identifier may be a flag, or any other suitable data values used as an identifier. The primary device may be configured to interpret the modified responses and determine which secondary devices have data for transmission based on the received advertisement responses.

Method 300 may perform operation 306 during which a network schedule may be updated based on a result of the determining. In various embodiments, the primary device may update the previously negotiated network schedule based on the received data transmission information. More specifically, the primary device may skip data exchange operations for any secondary device that does not have data to transmit.

Method 300 may perform operation 308 during which data exchange operations may be performed based on the updated network schedule. In various embodiments, the updated network schedule may be used for the next data exchange period. Accordingly, data exchange operations may be skipped for secondary devices with no data to transmit, and data exchange operations may be performed for secondary devices that previously indicated they have data to transmit.

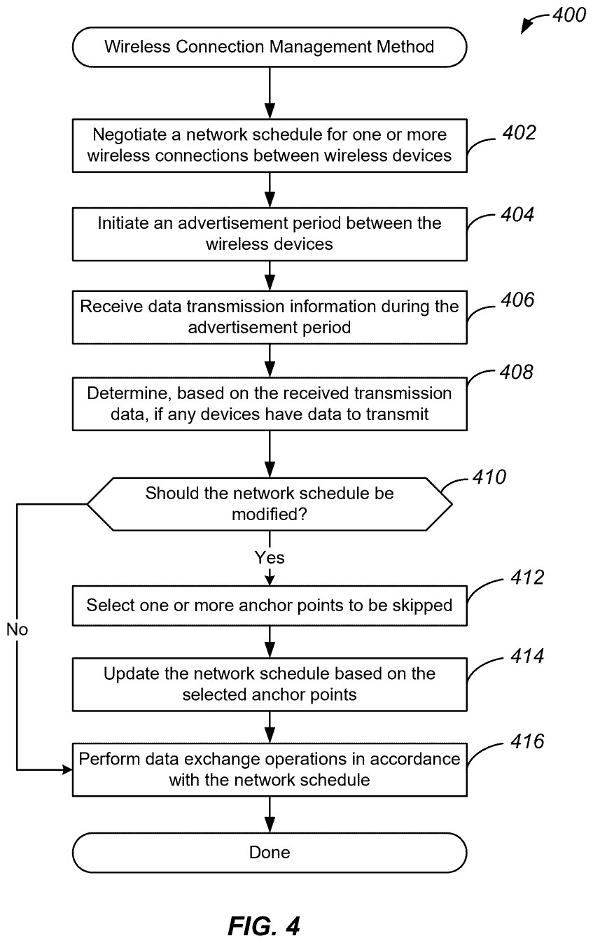

FIG. 4 illustrates another example of a method for wireless connection management, performed in accordance with some embodiments. Accordingly, a method, such as method 400, may be performed to generate network schedules used for wireless communications, and to update such network schedules based on received data transmission information. As will be discussed in greater detail below, data packets and frames exchanged during an advertisement period may be configured to additionally include data transmission information for multiple secondary devices for an upcoming period of data exchange. Moreover, a primary device may be configured to parse such information and update a network schedule in advance of the upcoming period of data exchange to skip scheduled data exchange operations that do not include a data payload. Removal of such scheduled data exchange operations may reduce overall power consumption and wireless resource usage of the wireless devices.

Method 400 may perform operation 402 during which a network schedule may be negotiated for one or more wireless connections between wireless devices. As discussed above, a primary device may be in communication with multiple secondary devices and may manage communications with the secondary devices to allocate wireless medium access for such secondary devices. In one example, during connection establishment operations, the primary device may communicate with the secondary devices to agree upon a scheduled wake time and sleep time for each secondary device, and a scheduled time at which the primary device will send information to each secondary device, and at which each secondary device may send information to the primary device. The beginning of a time at which the primary device sends information to a secondary device may be referred to herein as an anchor point for that associated period of data exchange for that secondary device. The negotiated schedule may be stored in memory as a network schedule.

Method 400 may perform operation 404 during which an advertisement period may be initiated. As discussed above, the advertisement period may be implemented using a wireless standard, such as Bluetooth Low Energy or Bluetooth Smart. In one example, the advertisement period is a periodic advertisement period implemented using PAwR features of Bluetooth Low Energy. Such advertisement periods may be periodically performed in accordance with the wireless standard, and may be interleaved between periods of data exchange. Accordingly, during operation 404, a primary device may perform advertisement activity in which advertisement data packets are broadcast on wireless channels dedicated to advertisement activity. For example, three wireless channels may be dedicated to advertisement activity, as may be specified by the wireless standard, and these channels may be different than those used for normal data exchange operations. Accordingly, advertisement data packets may be broadcast on the advertisement wireless channels.

Method 400 may perform operation 406 during which data transmission information may be received during the advertisement period. As discussed above, a periodic advertisement period may be used to perform PAwR operations in accordance with a wireless communications standard, such as a Bluetooth Low Energy standard. During operation 406, secondary devices may provide a reply to the primary device that broadcast the advertisement data packets. As will be discussed in greater detail below with reference to FIG. 6, the replies may be sent in accordance with response slots allocated to the secondary devices.

In various embodiments, the response is an advertisement data packet that is configured to additionally include an identifier that identifies whether or not a secondary device has data to transmit in an upcoming data exchange period. Accordingly, the secondary device may be configured to send data packets configured to include the advertisement reply and the data transmission information. During operation 406, such response data packets may be received from all of the secondary devices connected to the primary device.

Method 400 may perform operation 408 during which it may be determined if any devices have data to transmit. Accordingly, the primary device may receive responses from the secondary devices during the periodic advertisement period. The responses may be reply data packets, and the primary device may use data payloads of the reply data packets to determine if any of the secondary devices have indicated they have data to transmit. Accordingly, the primary device may receive all of the reply data packets during the periodic advertisement period, may analyze an identifier included in each of the reply data packets, and may identify each secondary device that has data to transmit, and also identify each secondary device that does not have data to transmit during an upcoming data exchange period.

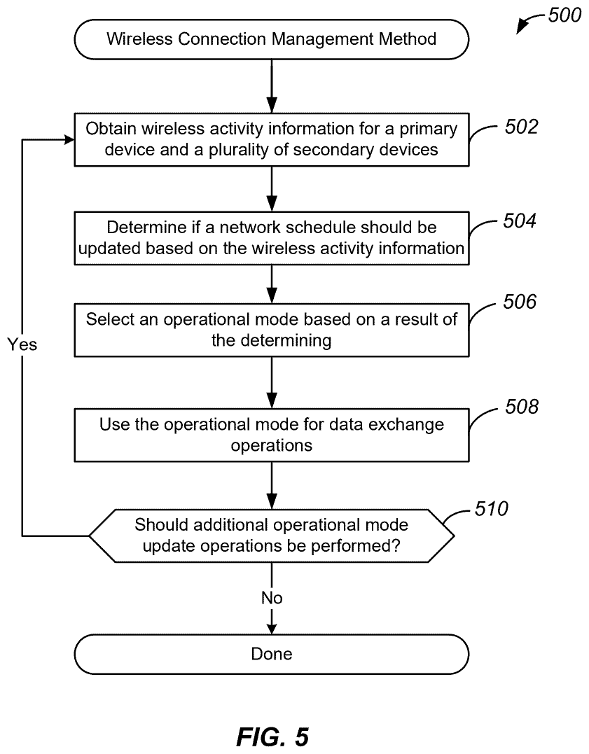

Method 400 may perform operation 410 during which it may be determined if the network schedule should be modified. As will be discussed in greater detail below with reference to FIG. 5, the transmission data may be used to determine if any updates or changes should be made to the network schedule. More specifically, the primary device may use the transmission data represented by the identifiers to determine if one or more secondary devices should be skipped. Such a determination may be made based on whether or not the identifiers identify that no data is to be transmitted. Accordingly, if it is determined that no change should be made to the network schedule, as may be the case if all secondary devices have data to transmit, then method 400 may proceed to operation 416 discussed in greater detail below. If it is determined the network schedule should be modified, then method 400 may proceed to operation 412.

Accordingly, during operation 412, one or more anchor points may be selected. In various embodiments, anchor points associated with secondary devices that have identified that they do not have data to transmit may be selected. As previously discussed, such anchor points may have been previously negotiated when the network schedule was initially established.

Method 400 may perform operation 414 during which the network schedule may be updated based on a result of the determining. In various embodiments, the primary device may skip data exchange operations for any secondary device that does not have data to transmit. Accordingly, the primary device may update the network schedule to skip anchor points for those secondary devices that have indicated that they have no data to transmit.

Method 400 may perform operation 416 during which data exchange operations may be performed based on the updated network schedule. In various embodiments, the updated network schedule may be used for the next data exchange period. Accordingly, data exchange operations may be skipped for secondary devices with no data to transmit, and data exchange operations may be performed for secondary devices that previously indicated they have data to transmit. In this way, transmission data received in advance via a periodic advertisement period may be used to modify and update a network schedule for a subsequent data exchange period.

FIG. 5 illustrates an additional example of a method for wireless connection management, performed in accordance with some embodiments. Accordingly, a method, such as method 500, may be performed to determine if updating of network schedules based on received data transmission information should be implemented. As will be discussed in greater detail below, a primary device may be configured to selectively implement an operational mode in which a periodic advertisement period is used to obtain data transmission information that may be used to update a network schedule. More specifically, the primary device may operate in a first mode in which periodic advertisement periods are interleaved with data exchange periods, and are also used to receive data transmission information. The primary device may also operate in a second mode where no periodic advertisement periods are used, and data exchange operations are performed for all secondary devices. Accordingly, method 500 may be performed to dynamically select and implement an operational mode.

Method 500 may perform operation 502 during which wireless activity information may be obtained for a primary device and a plurality of secondary devices. In various embodiments, the wireless activity information may represent an amount of activity, represented by data exchange events, occur over a wireless channel for a given data exchange period. Such wireless activity information may be observed during an observation or assessment period. Accordingly, the primary device may observe responses provided by secondary devices during a data exchange period, and may identify how many secondary devices had data to transmit, and also how many devices simply provided an acknowledgement response, but had no data to transmit. The primary device may also know how many secondary devices are connected based on previous connection establishment operations as well as a number of replies received.

In some embodiments, instead of obtaining wireless activity information during an observation period, one or more designated parameters specified by an entity, such as a manufacturer, may be used. Accordingly, a specified estimate of an among of activity may have been generated and stored in the primary device by the manufacturer, and such designated parameters may identify estimated wireless activity information. In some embodiments, the wireless activity information may be stored as one or more data values representing a number of devices having data to transmit, or a percentage of a total number of devices. It will be appreciated that any suitable representation of wireless activity may be used.

Method 500 may perform operation 504 during which it may be determined if a network schedule should be updated based on the wireless activity information. In various embodiments, such a determination may be made based on the wireless activity information as well as one or more other performance parameters which may have been generated and stored in the primary device by an entity, such as a manufacturer. In one example, the determination may be made by balancing a time taken by the periodic advertisement period, which may be an iteration of modified PAwR activity, with a time saved by skipping anchor points. In such an example, the time taken by the periodic advertisement period may be known and may be computed based on wireless standard parameters specifying times taken by operations within the periodic advertisement period. The time saved by skipping anchor points may be estimated based on the wireless activity information. For example, the primary device use the wireless activity information to approximate a number of anchor points that will be skipped based on the estimated number of secondary devices transmitting data. The primary device may then compute a time saved by multiplying the number of skipped anchor points with the time associated with a data exchange operation for each secondary device, as may be specified by a wireless standard. The primary device may then compare the time taken by the periodic advertisement period with the time saved by the skipped anchor points to determine if the network schedule updating should be performed.

In one example, transmission time, medium usage, and power consumption may be reduced when a number of secondary devices is larger and an amount of wireless activity is relatively small. In various embodiments, other performance parameters may be used instead of or in addition to a time taken by advertisement and data exchange operations. For example, the performance parameters may be a wireless medium occupancy metric which may be represented by a percentage of wireless medium usage. In another example, the performance parameters may be a transmit frequency and/or a transmit duration represented by a number and/or duration of transmission events performed by secondary devices.

Method 500 may perform operation 506 during which an operational mode may be selected based on a result of the determining. Accordingly, as discussed above, the primary device may have identified an operational mode based on the comparison of the wireless activity information and the performance parameters. More specifically, the primary device may select a first mode, in which periodic advertisement periods are interleaved with data exchange periods, if it is determined that the time saved by skipping anchor points is greater than the time taken by the periodic advertisement period. The primary device may select a second mode, where no periodic advertisement periods are used, if it is determined that the time saved by skipping anchor points is less than or equal to the time taken by the periodic advertisement period. Moreover, as also discussed above, any other suitable performance parameter may form the basis of this determination.

Method 500 may perform operation 508 during which the operational mode may be used for data exchange operations. Accordingly, the primary device and secondary devices may perform data exchange operations in accordance with the selected operational mode, as discussed above with reference to FIG. 4.

Method 500 may perform operation 510 during which it may be determined if additional operational mode update operations should be performed. In various embodiments, such a determination may be made based on the passage of a designated amount of time and/or a designated number of data exchange periods. In this way, such a determination may be made periodically in accordance with a temporal parameter that may be specified by an entity, such as a manufacturer. In some embodiments, such a determination may be made dynamically and in response to the occurrence of one or more network events. For example, a change in a number of secondary devices or a change in a status of a secondary device may trigger additional operational mode update operations. In another example, such additional update operations may be performed in response to a message provided by a secondary device. If it is determined that additional operational mode update operations should be performed, method 500 may return to operation 502. If it is determined that no additional operational mode operations should be performed, method 500 may terminate.

FIG. 6 illustrates a diagram of an example of wireless connection operations, configured in accordance with some embodiments. More specifically, image 600 illustrates an example of a periodic advertisement period as similarly discussed above. In this example, a primary device may send advertisement packet 602. A schedule may have been previously negotiated in which secondary devices are grouped and associated with response units, such as response unit 604, which may also be referred to as subevents. Such grouping may be performed based on one or more device features, such as hardware capabilities, of such secondary devices. Moreover, within each response unit may be subdivided into response slots assigned to secondary devices within each group. For example, response slot 606 may be assigned to a first secondary device, response slot 608 may be assigned to a second secondary device, and response slot 610 may be assigned to an nth secondary device. In this way, response slots may be generated and apportioned to secondary devices within a PAwR framework of a periodic advertisement period.

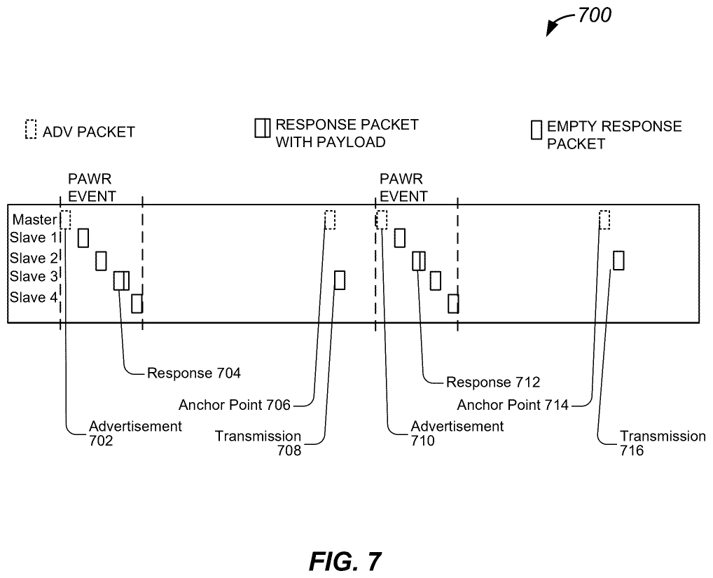

FIG. 7 illustrates a diagram of another example of wireless connection operations, performed in accordance with some embodiments. As shown in image 700, periodic advertisement periods may be interleaved between data exchange periods. More specifically, during a period advertisement period, an advertisement data packet, such as advertisement 702, may be broadcast to multiple secondary devices. In this example, there are four secondary devices connected to the primary device. Accordingly, as shown in FIG. 7, each secondary device may provide a response in accordance with its assigned response slot, as discussed above. Moreover, one or more of the responses may be modified as disclosed herein to include a data payload indicating that the associated secondary device has data to transmit during an upcoming data exchange period. In this example, response 704 is an advertisement response data packet that has been configured to include such an identifier in a data payload, and identifies that device 3 has data to transmit.

Image 700 further illustrates how such information is used by the primary device to update a network schedule for the subsequent data exchange period. More specifically, anchor points for device 1, device 2, and device 4 are skipped, and anchor point 706 associated with device 3 remains. As discussed above, the anchor point may identify a point at which the primary device sends a message to the secondary device, which ius device 3 in this example, and the secondary device provides a reply, as shown by transmission 708, that includes the data to be transmitted and that was previously forecasted by the identifier included in response 704.

As shown in image 700, the messages/responses associated with anchor points for device 1, device 2, and device 4 have been skipped, thus reducing power consumption and medium usage associated with such operations. As discussed above, when using conventional techniques, such messages/responses would include waking the devices and exchanging a message and response to indicate that the secondary device has no data to transmit. Embodiments disclosed herein provide the ability to skip such unnecessary message/response exchanges.

Image 700 further illustrates an additional periodic advertisement period in which advertisement 710 is broadcast, and response 712 indicates that device 2 has data to transmit. Accordingly, the primary device updates the network schedule to skip anchor points associated with device 1, device 3, and device 4, and a data exchange period is performed in which anchor points associated with device 1, device 3, and device 4 are skipped, and data exchange is performed for device 2 as shown by anchor point 714 and transmission 716.

Although the foregoing concepts have been described in some detail for purposes of clarity of understanding, it will be apparent that certain changes and modifications may be practiced within the scope of the appended claims. It should be noted that there are many alternative ways of implementing the processes, systems, and devices. Accordingly, the present examples are to be considered as illustrative and not restrictive.

What is claimed is:

1. A method comprising:
receiving data transmission information during an advertisement period via at least one advertisement response data packets;
determining, using one or more processors of a primary wireless device, if any of a plurality of secondary wireless devices has data to transmit during an upcoming data exchange period, the determining being based on the data transmission information;
updating, using the one or more processors, a network schedule based on a result of the determining, the updating comprising skipping data exchange operations for at least one of the plurality of secondary wireless devices; and
performing, using the one or more processors, data exchange operations using the updated network schedule.

2. The method of claim 1, wherein the advertisement period is a periodic advertisement with response assistance (PAwR) period.

3. The method of claim 2, wherein the data transmission information is received via a modified response within the PAwR period.

4. The method of claim 3, wherein the data transmission information comprises:
an identifier configured to identify if any of a plurality of secondary devices has data to transmit during an upcoming data exchange period.

5. The method of claim 4, wherein the plurality of secondary devices comprises Internet of Things (IoT) devices.

6. The method of claim 1, wherein the updating of the network schedule comprises:
identifying at least one anchor point within the network schedule based on the data transmission information; and
updating the network schedule to skip the identified at least one anchor point.

7. The method of claim 1 further comprising:
selecting an operational mode based on wireless activity information associated with the plurality of secondary devices.

8. The method of claim 7, wherein the selecting further comprises:
determining if a time taken by the advertisement period is less than an estimated time taken by an upcoming data exchange operation; and
selecting the operational mode based on a result of the determining.

9. The method of claim 1, wherein the primary wireless device and the plurality of secondary wireless devices are compatible with a Bluetooth Low Energy protocol.

10. A system comprising:
a transceiver configured to transmit and receive wireless signals compatible with a wireless communications protocol;
a processing device comprising one or more processors configured to:
receive data transmission information during an advertisement period via at least one advertisement response data packets;
determine if any of a plurality of secondary wireless devices has data to transmit during an upcoming data exchange period, the determining being based on the data transmission information;
updating a network schedule based on a result of the determining, the updating comprising skipping data exchange operations for at least one of the plurality of secondary wireless devices; and
performing data exchange operations using the updated network schedule.

11. The system of claim 10, wherein the advertisement period is a periodic advertisement with response assistance (PAwR) period, and wherein the data transmission information is received via a modified response within the PAwR period.

12. The system of claim 11, wherein the data transmission information comprises:
an identifier configured to identify if any of a plurality of secondary devices has data to transmit during an upcoming data exchange period.

13. The system of claim 10, wherein the one or more processors are further configured to:
identify at least one anchor point within the network schedule based on the data transmission information; and
update the network schedule to skip the identified at least one anchor point.

14. The system of claim 10, wherein the one or more processors are further configured to:
select an operational mode based on wireless activity information associated with the plurality of secondary devices.

15. The system of claim 14, wherein the one or more processors are further configured to:
determine if a time taken by the advertisement period is less than an estimated time taken by an upcoming data exchange operation; and
select the operational mode based on a result of the determining.

16. A device comprising:
one or more processors configured to:
receive data transmission information during an advertisement period via at least one advertisement response data packets;
determine if any of a plurality of secondary wireless devices has data to transmit during an upcoming data exchange period, the determining being based on the data transmission information;
updating a network schedule based on a result of the determining, the updating comprising skipping data exchange operations for at least one of the plurality of secondary wireless devices; and
performing data exchange operations using the updated network schedule.

17. The device of claim 16, wherein the advertisement period is a periodic advertisement with response assistance (PAwR) period, and wherein the data transmission information is received via a modified response within the PAwR period.

18. The device of claim 16, wherein the one or more processors are further configured to:
identify at least one anchor point within the network schedule based on the data transmission information; and
update the network schedule to skip the identified at least one anchor point.

19. The device of claim 10, wherein the one or more processors are further configured to:
select an operational mode based on wireless activity information associated with the plurality of secondary devices.

20. The device of claim 19, wherein the one or more processors are further configured to:
determine if a time taken by the advertisement period is less than an estimated time taken by an upcoming data exchange operation; and
select the operational mode based on a result of the determining.
